(19) United States
(12) Patent Application Publication
(10) Pub. No.: US 2026/0254550 A1
(43) Pub. Date: Aug. 27, 2026

(54) OPTICAL NETWORK COMPONENT CONFIGURATION

(71) Applicant: Telefonaktiebolaget LM Ericsson (publ), Stockholm (SE)

(72) Inventors: Roberto MAGRI, Genova (IT); Stefano ORSI, Genova (IT); Alberto DEHO, Genova (IT); Claudio D'INCÀ, Genova (IT); Sergio MOSTI, Genova (IT)

(73) Assignee: Telefonaktiebolaget LM Ericsson (publ), Stockholm (SE)

(21) Appl. No.: 19/160,107

(22) PCT Filed: Mar. 2, 2023
(86) PCT No.: PCT/EP2023/055343

§ 371 Date: Aug. 27, 2025

(51) Int. Cl. H04J 14/02; G02B 6/293; G02B 6/35

(52) U.S. Cl. CPC H04J 14/0212; G02B 6/29383; G02B 6/3504; H04J 14/0213

(57) ABSTRACT

An optical add drop multiplexer, OADM, includes a first west port (W1) coupled to a first east port (E1) by a first filter arrangement, the first filter arrangement including a plurality of filter elements and a second west port (W2) coupled to a second east port (E2) by a second filter arrangement to provide a second optical signal path, the second filter arrangement including a plurality of filter elements. The OADM also comprises an interconnection arrangement switchable between: a first mode in which the add ports (A1-A6) are coupled to respective filter elements of the first filter arrangement and the drop ports (D1-D6) are coupled to respective filter elements of the second filter arrangement; and a second mode in which some of the add ports (A1-A6) and some of the drop ports (D1-D6) are coupled to respective filter elements of the first filter arrangement or the second filter arrangement.

### TECHNICAL FIELD

Examples of the present disclosure relate to methods and apparatus for mode control of optical networks, including a reconfigurable Optical Add Drop Multiplexer and/or an interconnection arrangement.

### BACKGROUND

Optical networks may be implemented for the provision of communications fronthaul services for remote radio antenna sites as well as for urban aggregation and transport for office buildings, houses, factories, hospitals, other infrastructure, and the like as well as for long haul transport. These implementations typically utilize Wave Division Multiplexing (WDM) technology for multiplexing multiple optical channels over one or more optical fibers, depending on the network topologies and requirements of the network. In some implementations where nodes require high reliability and/or large bandwidths, ring networks may be employed, whereas remote relatively low bandwidth nodes may be served using point-to-point (P2P) or point-to-multi-point (P2MP) topologies.

Different numbers of optical fiber links between nodes may also be employed depending on communications requirements. Single Fiber Working (SFW) utilizes one optical fiber between nodes to carry wavelengths for both uplink and downlink transmissions (ie multiplexed (WDM) optical signal propagation in both directions). Dual Fiber Working (DFW) uses two optical fibers between nodes, one fiber to carry wavelengths or optical channels for uplink transmissions and a different fiber to carry wavelengths or optical channels for downlink transmissions. DFW provides greater capacity at the expense of requiring an additional fiber. These topologies find application both in Radio Access Networks (RAN) where they are designed to operate in SFW to make better utilization of the precious fiber resource, and in aggregation/metro and long-haul networks where they're designed to operate in DFW (separate fibers for the two optical signal propagation directions). Other topologies are possible such as Dual SFW (D-SFW) in which two optical fibers are provided between nodes but each optical fiber carries wavelengths for both uplink and downlink transmissions.

Each node typically includes an Optical Add Drop Multiplexer (OADM) to allow one or more downlink wavelengths to be received or dropped from the multiplexed (WDM) optical signal on an “incoming” optical fiber as well as to allow one or more uplink wavelengths to be transmitted on or added to the multiplexed optical signal on an “outgoing” optical fiber. Other wavelengths are passed through from one optical fiber to the other. Low cost and low complexity are usually desirable features of an optical network given the large geographical area that they may be distributed over as well as the difficulty of accessing equipment within some nodes. OADM are therefore often provided as fixed passive devices where dynamic reconfigurability is not required. More complex solutions or nodes may require active reconfigurable OADM (ROADM).

The OADM filter design for SFW and DFW needs specific connecting optical fiber connections between components such as filters and add/drop ports. Field technicians also need to connect user equipment to these ports based on wavelengths allocated to each respective node in an optical network. SFW requires different wavelengths in the transmission (Tx) or uplink direction and the receiving (Rx) or downlink direction in order to avoid crosstalk issues due to reflections. DFW instead uses the same wavelength for the two directions (Tx or Rx) of propagation for each channel, but in different optical fibers. The front panel of the OADM enclosure is typically designed to use duplex connectors for Tx (Add) and Rx (Drop) ports on each channel or wavelength in order to improve serviceability and avoid mis-connections by field technicians during installation. The duplex connector may tighten the Tx and Rx connectors together. The resulting cabling to user equipment is also cleaner. For this reason, OADM designs are different for SFW and DFW applications, with different fiber connections inside the case between the filter components and the front-panel connectors to keep the duplex connection on the front. Different products must be designed, specified, supplied, and maintained in the product portfolio, as well as being housed and tracked as different spare parts. This leads to higher costs and efforts.

### SUMMARY

In one aspect there is provided an optical add drop multiplexer (OADM) comprising: a first west port coupled to a first east port by a first filter arrangement, the first filter arrangement comprising a plurality of filter elements associated with respective wavelengths; a second west port coupled to a second east port by a second filter arrangement to provide a second optical signal path, the second filter arrangement comprising a plurality of filter elements associated with the respective wavelengths; and an interconnection arrangement to couple the filter elements of the first and second filter arrangements to respective add ports or respective drop ports. The interconnection arrangement is switchable between a first mode in which the add ports are coupled to respective filter elements of the first filter arrangement and the drop ports are coupled to respective filter elements of the second filter arrangement, and a second mode in which some of the add ports and some of the drop ports are coupled to respective filter elements of the first filter arrangement or the second filter arrangement. By providing a simple optical network reconfiguration arrangement in which an OADM may be easily configurable for SFW or DFW, costs and efforts involved in installing, maintaining and reconfiguring optical networks can be improved. In some embodiments a mechanically operated interconnection arrangement is employed to convert or reconfigure an OADM between SFW and DFW modes of operation. This reduces cost for an operator as well as enabling simple configuration at installation or reconfiguration, thereby also reducing field technician training requirements and errors.

In another aspect there is provided an interconnection arrangement comprising means for switchably coupling add ports and drop ports to respective filter elements (510a, 510b) in first and second filter arrangements in an OADM. The interconnection arrangement is switchable between a first mode in which the add ports are coupled to respective filter elements of the first filter arrangement and the drop ports are coupled to respective filter elements of the second filter arrangement, and a second mode in which some of the add ports and some of the drop ports are coupled to respective filter elements of the first filter arrangement or the second filter arrangement.

In other aspects there is provided an optical communications node and an optical network.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic illustration of an optical ring network using DFW according to an example;

FIG. 2 is a schematic illustration of an optical network using SFW according to an embodiment;

FIG. 3 is a schematic illustration of an OADM configured for DFW according to an embodiment;

FIG. 4 is a schematic illustration of an OADM configured for Dual-SFW according to an embodiment;

FIG. 5 is a schematic illustration of an interconnection arrangement of an OADM configured for DFW according to an embodiment;

FIG. 6 is a schematic illustration of an interconnection arrangement of an OADM configured for Dual-SFW according to an embodiment;

FIGS. 7a, 7b, 7c illustrate operation of an interconnection arrangement according to an embodiment;

FIGS. 8a and 8b illustrate mechanical components of the interconnection arrangement of FIGS. 7a-c; and

FIG. 9 illustrates the components of an OADM enclosure according to an embodiment.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

FIG. 1 shows an example of an optical ring network 100 according to an embodiment. The network 100 comprises a number of optical communications nodes 105, each coupled to an adjacent node by two optical fibers 110a, 110b in a Dual Fiber Working (DFW) topology. In DFW, each fiber carries wavelengths in only one direction (uplink or downlink). Each node comprises an OADM 115a which drops (D) one or more wavelengths from one of the optical fibers 110a and adds (A) one or more wavelengths to the other optical fiber 110b. Such an arrangements may be useful for aggregation/metro and long-haul networks.

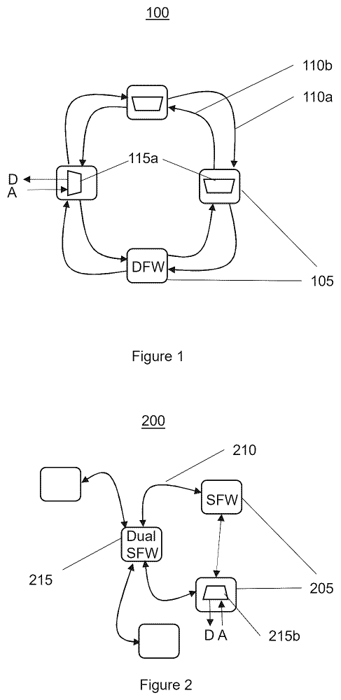

FIG. 2 shows an example of an optical network 200 according to an embodiment. The network 200 comprises a number of optical communications nodes, each coupled to an adjacent node by one optical fiber 210 in a Single Fiber Working (SFW) topology. In SFW, each fiber carries wavelengths in both directions (uplink and downlink). Each node comprises an OADM 215b which drops (D) one or more wavelengths from the optical fiber 210 and adds (A) one or more wavelengths to the same optical fiber 210. Such an arrangements may be useful for radio access networks (RAN) comprising a number of remote nodes.

Other optical network architectures are also possible such as a linear link comprising end nodes and a number of intermediate nodes. OFDM may be employed in each of the intermediate nodes and optical terminals may be used at the two end nodes in order to convert signals on all allocated optical wavelengths or channels into or from the electrical domain.

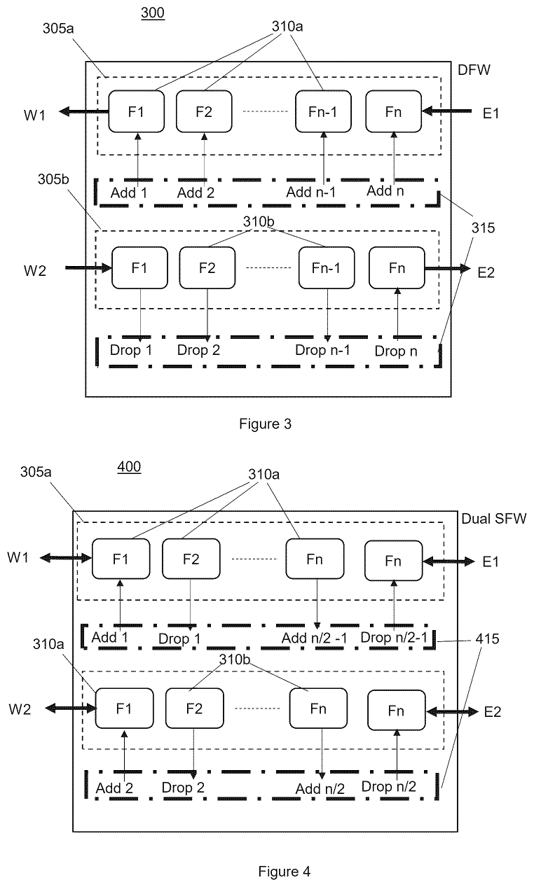

FIGS. 3 and 4 illustrate schematically an OADM configured in DFW (300) and DSFW (400) modes of operation. Referring initially to FIG. 3, the OADM 300 is configured for DFW operation and comprises a first filter arrangement 305a coupled to a first West port W1 and a first East port E1. The terms West and East are simply intended to distinguish between different OADM inputs/outputs or physical couplings to different external optical fibers to other nodes and do not imply that these are oriented in a specific direction. The first filter arrangement 305a comprises a plurality of filter elements 310a each associated with a respective wavelength F1-Fn, where n is any number integer than 1.

In one example, the filter arrangement may comprise Bragg gratings in which each grating corresponds to a different frequency or wavelength. This enables a wavelength corresponding to a grating to be removed or dropped from a multiplexed optical signal on an optical fiber coupled to an adjacent node (via first West port W1) to be received by user equipment connected to the corresponding Drop port of the OADM. Similarly, this also enables a wavelength corresponding to a grating to be added to a multiplexed optical signal on an optical fiber coupled to another adjacent node (via first East port E1), the added signal having been transmitted by user equipment connected to the corresponding Add port of the OADM. In other examples, alternative filter elements may be employed such as Thin Film Filters (TTF).

Each node will be allocated one or more respective wavelengths for transmission (Add) and reception (Drop), and a field technician may then couple equipment to Add/Drop ports corresponding to those wavelengths. The user equipment may include optical transceivers, optical-to-electrical conversion equipment, radio transmission equipment, household appliances and the like. Allocating different wavelengths to different nodes ensures that they do not interfere with each other when both trying to communicate across the network.

The OADM 300 also comprises a second filter arrangement 305b coupled to a second West port W2 and a second East port E2. These terms again simply refer to different OADM inputs/outputs or physical couplings for different optical fibers to different adjacent nodes and do not imply that these are oriented in a specific direction. The second filter arrangement 305b comprises a plurality of filter elements 310b each associated with a respective wavelength F1-Fn. In this example, the filter elements 310b of the second filter arrangement 305b have the same set of wavelengths as the filter elements 310a of the first filter arrangement.

The OADM 300 also comprises an interconnection arrangement 315 which couples each filter element 310a, 310b to a respective Add or Drop port. In FIG. 3, the OADM is configured for DFW operation and so each filter element 310a of the first filter arrangement 305a is optically coupled by the interconnection arrangement 315 to a respective Add port (Add 1, Add 2 . . . Add n) and each filter element 310b of the second filter arrangement 305b is optically coupled by the interconnection arrangement 315 to a respective Drop port (Drop 1, Drop 2 . . . Drop n). In another example the Add ports may be coupled to the filter elements 310b of the second filter arrangement 305b and the Drop ports may be coupled to the filter elements 310a of the first filter arrangement 305a. In each case, wavelengths are only added to one multiplexed optical signal on one of the optical pathways (e.g. W1&E1) and wavelengths are only dropped from another multiplexed optical signal on a different optical pathway (e.g. W2&E2).

Referring now to FIG. 4, this shows the same OADM components as FIG. 3, but configured for Dual SFW (DSFW) operation. The filter arrangements and their connections to the external ports (W1, E1, W2, E2) are the same, however the interconnections between each filter element and the add and drop ports are different. In this DSFW configuration, two multiplexed optical signals are still provided, one on a first optical pathway (W1, 305a, E1) and the other on a second optical pathway (W2, 305b, E2). However, in this SFW mode, wavelengths are both dropped and added to both multiplexed optical signals.

In the OADM 400, the reconfigured interconnection arrangement 415 is adapted to optically couple each filter element 310a of the first filter arrangement 310a to respective Add or Drop ports (Add 1, Drop 1, Add 3, Drop 3 . . . Add n/2-1, Drop n/2-1). Similarly, the interconnection arrangement 415 is adapted to optically couple each filter element 310b of the second filter arrangement 310b to respective Add or Drop ports (Add 2, Drop 2, Add 4, Drop 4 . . . . Add n/2, Drop n/2). In an alternative arrangement, different Add and Drop ports may be coupled to the filter elements of the first and second filter arrangements 305a, 305b.

In an alternative arrangement, the OADM may be configurable between a DFW mode and a nondual (or single) SFW mode of operation. In this case, when switching to SFW mode, Add and Drop ports may be only coupled to filter elements 310a or 310b of one of the filter arrangements 305a or 305b. The unused Add/Drop ports and filter elements 310a or 310b of the other filter arrangement may be uncoupled from each other. This may allow an OADM to be configurable between DFW and SFW (not Dual SFW) modes which may be useful in some situations, such as when an operator does not have any Dual SFW topologies.

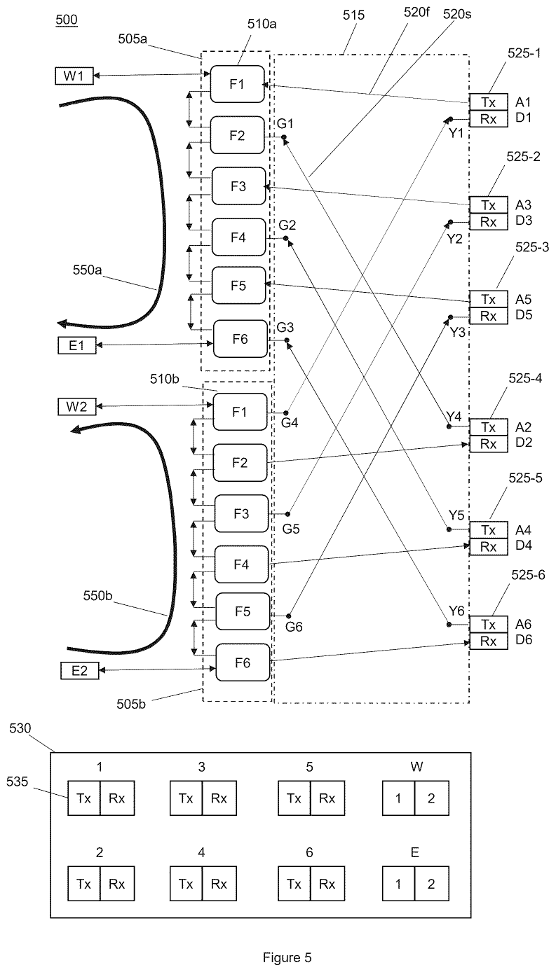

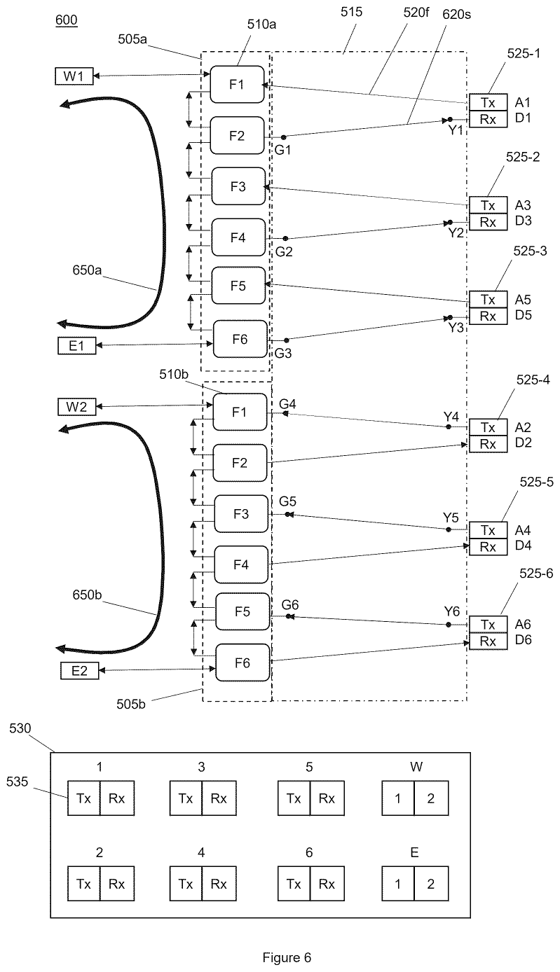

FIGS. 5 and 6 illustrate OADM configurations in more detail for DFW (500) and Dual-SFW (600) modes of operation, according to one example. Referring initially to FIG. 5, the OADM 500 comprises a first filter arrangement 505a coupled to a first West port W1 and a first East port E1. The first filter arrangement 505a comprises a plurality of filter elements 510a each associated with a respective wavelength F1-F6. The OADM 500 also comprises a second filter arrangement 505b coupled to a second West port W2 and a second East port E2. The second filter arrangement 505b comprises a plurality of filter elements 510b each associated with a respective wavelength F1-F6.

The OADM 500 also comprises an interconnection arrangement 515 configured for a DFW mode of operation. The interconnection arrangement comprises optical couplings 520f, 520s between each filter element 510a, 510b and an Add or Drop port A1, D1 . . . A6, D6. The optical couplings may be short lengths of optical fiber and switchable optical connections, for example as described in more detail below. Pairs of Add and Drop ports (525-1-525-6) may be formed, which may simplify installation of the OADM by field technicians. Some optical couplings 520f are fixed irrespective of the configuration of the interconnection arrangement, and permanently couple one filter element (e.g. 510a F1) to one Add or Drop port (A1). Some optical couplings 520s are switchable depending on the configuration of the interconnection arrangement, and switchably couple one filter element (e.g. 510a F2) between two Add or Drop ports (e.g. D2 or D1 in FIG. 6).

For ease of explanation, each filter element having a switching coupling is associated with a switching node—F2 and G1, F4 and G2, F6 and G3 in the first filter arrangement 505a, with F2 and G4, F4 and G5, F6 and G6 in the second filter arrangement 505b. Similarly, each Add or Drop port having a switchable coupling is associated with a switching node—D1 and Y1, D3 and Y2, D5 and Y3, A2 and Y4, A4 and Y5, A6 and Y6. The specific filters and/or ports that are connected to switchable connections could be different in other examples, similarly other parameters could also be varied such as the number of filter elements 510a, 510b, the number of Add and Drop ports, and whether or not to use pairing of Add/Drop ports.

In this example, the following switching node pairings are made to enable a DFW mode of operation: G1-Y4 (coupling filter element for F2 in the first filter arrangement to Add port A2); G2-Y5 (F4 in 505a to A4); G3-Y6 (F6 in 505a to A6); G4-Y1 (coupling filter element for F1 in the second filter arrangement to Drop port D1); G5-Y2 (F3 in 505b to D3); G6-Y3 (F5 in 505b to D5). It can be seen that all Drop ports (D1-D6) are coupled to respective filter elements F1-F6 in the second filter arrangement 505b whilst all Add ports (A1-A6) are coupled to respective filter elements F1-F6 in the first filter arrangement 505a. This ensures that only wavelengths are added to the multiplexed optical signal 550a to/from ports W1 and E1; thus all wavelengths are provided for transmission or uplink only. This avoids interference with wavelengths used for the downlink. The downlink wavelengths are all provided on the other multiplexed optical signal 550b to/from ports W2 and E2. Wavelengths from this second multiplexed optical signal 550b are dropped from the second filter arrangement 505b to Drop ports D1-D6.

The front panel 530 of an OADM enclosure is shown with pairs of connectors 535 corresponding to respective pairs of Add/Drop ports 525-1-525-6, as well as the two West and East ports for the external optical fibers.

Referring to FIG. 6, the interconnection arrangement 515 of the reconfigured OADM 600 is now configured for a dual SFW (DSFW) mode of operation. The parts of the interconnection arrangement and the filter arrangements of the OADM are the same, however the switchable optical couplings 620s have changed so that the connections between the corresponding filter elements has changed to different Drop or Add ports to enable the DSFW mode. In this example, the following switching node pairings are made: G1-Y1 (coupling filter element for F2 in the first filter arrangement to Drop port D1); G2-Y2 (F4 in 505a to D3); G3-Y3 (F6 in 505a to D5); G4-Y4 (coupling filter element for F1 in the second filter arrangement to Add port A2); G5-Y5 (F3 in 505b to A4); G6-Y6 (F5 in 505b to A6).

It can be seen that the filter elements 510a for F1-F6 in the first filter arrangement 505a are coupled to both Add and Drop ports (A1, D1, A3, D3, A5, D5). Similarly, filter elements 510b for F1-F6 in the second filter arrangement 505b are coupled to both Add and Drop ports (A2, D2, A4, D4, A6, D6). This enables wavelengths to be added to and dropped from both of the multiplexed optical signals 650a and 650b. By switching between these two sets of interconnection arrangement couplings, the OADM may be switching between a DFW mode and a DSFW mode.

The switching of the interconnection arrangement may be implemented mechanically by changing the optical terminal positions of the switchable optical couplings 520s, 620s so that they connect with different Add/Drop ports or filter elements 510a, 510b. In alternative arrangements, the switching may be implemented using optical or electrical switches. For example, an array of two-by-two bistable electro optical switches may be employed, each connected to a Y (or G) node and switchable between two G (or Y) nodes as previously described. The interconnection arrangement reconfiguration may be performed using optical or electrical control signaling, for example utilizing a powered electro-mechanical controller which may be signaled remotely, or may be performed manually by a field technician as described in more detail below.

The front panel 530 of the OADM enclosure when reconfigured for DSFW mode of operation is unchanged, but the mapping of the connectors to filters or wavelengths will be changed according to the mode selected. This will require a field technician to connect user equipment according to allocated wavelengths for transmission and reception for the node containing the OADM.

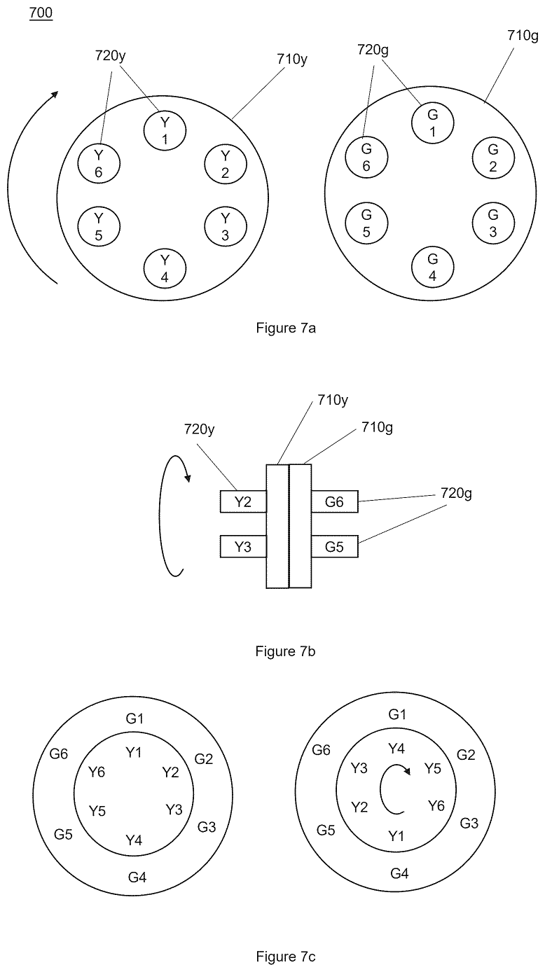

FIGS. 7a, 7b and 7c illustrate a mechanical implementation of an interconnection arrangement 700 which is switchable between two modes. FIG. 7a illustrates two interfaces 710y and 710g. These may be implemented by two circular face plates made of a suitable material such as a plastic or metal and which receive optical terminals 720y, 720g each corresponding to a switchable Y or G node in FIGS. 5 and 6. The optical terminals are the terminations of the switchable couplings 520s, 620s and are annularly arranged about their respective interfaces 710y, 710g. The optical terminals implemented using any suitable optical fiber termination technique such as ferules which are optically connectable to an optical socket. The optical terminals 720y on a first interface 710y are coupled to respective Add/Drop ports as follows: Y1-D1, Y2-D3, Y3-D5, Y4-A2, Y5-A4, Y6-A6. The optical terminals 720g on the other interface 710g are optically coupled to respective filter elements of the first or second filter arrangements as follows: G1-F2 of 505a, G2-F4 of 505a, G3-F6 of 505a, G4-F1 of 505b, G5-F3 of 505b, G6-F5 of 505b. Other mappings are possible.

FIG. 7b illustrates a side view of the interconnection assembly when the two interfaces 710y, 710g are physically located adjacent each other so that the optical terminals from each interface are optically connected to an optical terminal from the other interface. The interfaces 710y, 710g are rotatable with respect to each other so that the mapping between optical terminals can be changed.

Two different rotational positions of the interfaces 710y, 710g are illustrated schematically in FIG. 7c. In the position on the left, the following mapping is provided: G1-Y1, G2-Y2, G3-Y3, G4-Y4, G5-Y5, G6-Y6. This corresponds to the DSFW mode of FIG. 6. In the position on the right, the following mapping is provided: G1-Y4, G2-Y5, G3-Y6, G4-Y1, G5-Y2, G6-Y3. This corresponds to the DFW mode of FIG. 5. It can be seen that a rotation of 180 degrees is required to switch between the two modes. Alternative examples are possible which may include one or more linear movements of interfaces having optical terminals in a different non-annular arrangement.

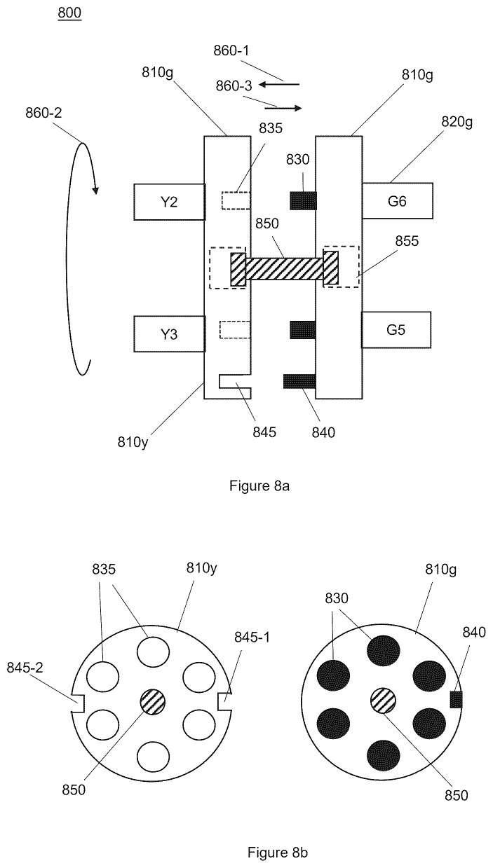

FIGS. 8a and 8b illustrate mechanical components which may be employed in an example interconnection arrangement such as that of FIGS. 7a-c. The mechanical components are arranged in order to limit the interconnection arrangement to two rotational positions in which the optical terminals are connected, which correspond to two modes of operation such as DFW and DSFW or DFW and SFW. Other rotational positions may result in configuration errors and interfere with the rest of the optical network.

The interconnection arrangement 800 of this example comprises two circular face plates 810g, 810y each comprising an optical terminal 830, 835 corresponding to a respective switching node Y1-Y6 and G1-G6. The optical terminals on one face plate 810g may comprise an optical fiber plug 830 or ferrule which fits into an optical fiber socket 835 of the other face plate 810g. Each of these optical terminals 830, 835 corresponds to a switching node Y1-Y6, G1-G6 which in turn are connected to an Add/Drop port or a filter element as previously described.

The interconnection arrangement 800 comprises an anchor 850 which mechanically couples the two face plates 810g, 810g and allows for rotation of one face plate with respect to the other face plate about their centers, as indicated by 860-2. The anchor 850 also allows lateral movement between the two face plates so that the face plates can move apart from each other (direction 860-1) and move back together (direction 860-3). The anchor 850 may comprise a metal or plastic cylinder with flanged ends as illustrated which interact with a recess 855 within each face plate 810g, 810y to limit lateral movements 860-1, 860-3 between the face plates being in physical contact and being spaced apart by a maximum distance. The anchor 850 may also include a spring or other resilient device to urge the two face plates 810y, 810g together so that a force must be applied to separate them. This also ensures that the optical terminals stay connected once a mode has been selected.

The interconnection arrangement 800 also comprises a limiter mechanism 840, 845-1, 845-2 to limit the rotational positions which the face plates 810y, 810g may adopt with respect to each other. This ensures that only couplings compatible with the two modes of the OADM can be selected. The limiter mechanism comprises a projection 840 fixed to one of the face plates 810g and two complementary recesses or holes 845-1, 845-2 into which the projection 840 may be received. If the projection 840 is not received into the recesses 845-1, 845-2, then the two face plates 810y, 810g are spaced apart and the optical terminals 830, 835 are not coupled. If the projection 840 is received into the recesses 845-1, 845-2, then the two face plates 810y, 810g are brought together such that the optical terminals 830, 835 are coupled. The position of the projection 840 and recesses 845-1, 845-2 are arranged such that the only two rotational positions in which the optical terminals of each face place can be coupled correspond to the two modes of the OADM as previously described. In an alternative, two projections may be provided 180 degrees apart.

In operation, a user may manually separate the two face plates 810y, 810g in direction 860-1, rotate one of the face plates 810g by 180 degrees with respect to the other face plate 810y in direction 860-2, and allow the two face plates to be pulled together in direction 860-3 under action of the anchor 850. This manual operation changes the mode of the OADM, for example from DSFW to DFW. The projection(s) 840 and recesses 845-1, 845-2 ensure that only two rotational positions are provided in which the optical terminals from each face plate can be connected, these corresponding to the two available modes of operation of the OADM.

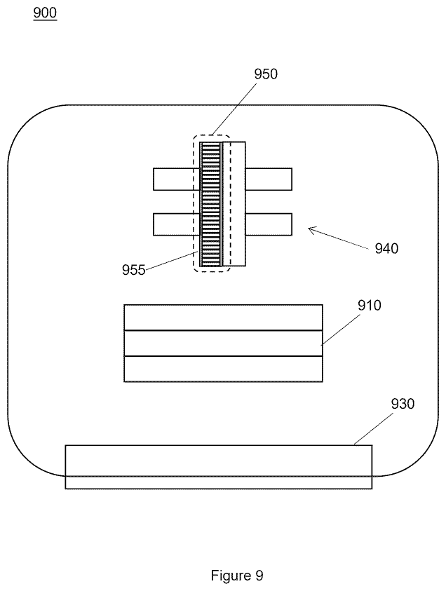

Manual selection of the wanted mode may be easily implemented in the field, for example as illustrated in FIG. 9. This figure illustrates an OADM enclosure 900 comprising filter elements 910 of first and second filter arrangements, a mechanical interconnection arrangement 940, and a connector panel 930. These components may be as previously described-for example the filter elements may correspond to 510a, 510b, the mechanical interconnection arrangement may correspond to 800 including 810g and 810 y, and the connector panel may correspond to 530. Optical fiber links between these components are not illustrated for simplicity.

The OADM enclosure 900 includes an opening 950 positioned over at least one of the face plates of the interconnection arrangement 940. The exposed face plate may include a textured surface 955 to facilitate manual movement of the faceplate, including separating this laterally from the other faceplate and rotating the exposed faceplate with respect to the other faceplate. As described above, this allows the mode of operation of the OADM to be changed manually, for example from DSFW to DFW, or vice versa. This can be achieved in the field without opening the OADM enclosure. Once the mode is selected, the connector panel 930 becomes usable for that mode.

Whilst six filter elements in each filter arrangement have been described, examples are not limited to this number and more generally any plural number of filter elements N may be employed-an even number of filter elements allows an even number of upstream and downstream channels in the SFW mode. Similarly, whilst the selection of one of two modes has been described, it is possible that a selection from three or more modes may be implemented; for example between DFW, SFW and DSFW. This may require more than one optical terminal per switching node Y1-Yn, G1-Gn and/or more than two interfaces as well as a limiter mechanism arranged to allow three (or more) positions of an interconnection arrangement in which optical terminals are connectable. Similarly, whilst manual mechanical operation of circular face plates of an interconnection arrangement has been described, face plates of different shapes and configurations as well as remote mechanical or optical-electrical operation of the interconnection arrangement is possible. Similarly multicore fibers and multicore ferrules may be employed in some examples.

Embodiments may provide a number of other advantages including providing a reconfigurable passive OADM solution and reduced OADM inventory with the same form factor for both configurations. This avoids the need to change optical filter design for different topologies and provides an improved solution for addressing different network segments such as access and metro/regional. There is also no need to develop, qualify and maintain different OADM equipment types for different applications and thereby consolidates the volume of these items on a single variant which provides costs savings.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1. An optical add drop multiplexer, OADM, comprising:
a first west port coupled to a first east port by a first filter arrangement, the first filter arrangement comprising a plurality of filter elements associated with respective wavelengths;
a second west port coupled to a second east port by a second filter arrangement to provide a second optical signal path, the second filter arrangement comprising a plurality of filter elements associated with the respective wavelengths;
an interconnection arrangement to couple the filter elements of the first and second filter arrangements to respective add ports or respective drop ports, wherein the interconnection arrangement is switchable between:
a first mode in which the add ports are coupled to respective filter elements of the first filter arrangement and the drop ports are coupled to respective filter elements of the second filter arrangement; and
a second mode in which some of the add ports and some of the drop ports are coupled to respective filter elements of the first filter arrangement or the second filter arrangement.

2. The OADM of claim 1, wherein in the second mode the other of the add ports and the drop ports are coupled to respective filter elements of the other of the second filter arrangement or the first filter arrangement.

3. The OADM of claim 1, wherein the interconnection arrangement is configured to switch between coupling some add ports and some drop ports from filter components having respective wavelengths in one filter arrangement to filter elements having different respective wavelengths in the other filter arrangement.

4. The OADM of claim 3, wherein the interconnection arrangement is configured to maintain the coupling between the other of the add ports and drop ports and respective filter elements when switching between the first and second modes.

5. The OADM of claim 1, wherein the interconnection arrangement is mechanically switchable.

6. The OADM of claim 5, wherein the interconnection arrangement comprises a first interface having optical terminals coupled to some of the filter elements of the first and the second filter arrangements and a second interface having optical terminals coupled to some of the add and drop ports; wherein one or both of the first and second interfaces is moveable to couple different pairs of optical terminals from the first and second interfaces.

7. The OADM of claim 7, wherein the optical terminals are annularly arranged on the respective first and second interfaces and wherein the first and second interfaces are rotatable with respect to each other.

8. The OADM of claim 7, comprising a limiter mechanism to limit the coupling of the optical terminals to two rotational positions of the first and second interfaces corresponding to the first and second modes.

9. The OADM of claim 8, wherein the limiter mechanism comprises a projection on one of the interfaces and two recesses for receiving the projection on the other interface.

10. The OADM of claim 5, wherein the interconnection is manually operable to switch between the first and second modes.

11. The OADM according to claim 1, wherein the first mode corresponds to a dual fiber working, DFW, mode and the second mode corresponds to a single fiber working, SFW, mode.

12. An optical communications node comprising an OADM according to claim 1.

13. An optical network comprising an optical communications node according to claim 12.

14. An interconnection arrangement comprising:
means for switchably coupling add ports and drop ports to respective filter elements in first and second filter arrangements in an OADM;
wherein the interconnection arrangement is switchable between:
a first mode in which the add ports are coupled to respective filter elements of the first filter arrangement and the drop ports are coupled to respective filter elements of the second filter arrangement; and
a second mode in which some of the add ports and some of the drop ports are coupled to respective filter elements of the first filter arrangement or the second filter arrangement.

15. The interconnection arrangement of claim 14, wherein in the second mode the other of the add ports and the drop ports are coupled to respective filter elements of the other of the second filter arrangement or the first filter arrangement.

16. The interconnection arrangement of claim 14, wherein the interconnection arrangement is configured to switch between coupling some add ports and some drop ports from filter components having respective wavelengths in one filter arrangement to filter elements having different respective wavelengths in the other filter arrangement.

17. The interconnection arrangement of claim 16, wherein the interconnection arrangement is configured to maintain the coupling between the other of the add ports and drop ports and respective filter elements when switching between the first and second modes; and wherein the interconnection arrangement is mechanically switchable.

18. (canceled)

19. The interconnection arrangement of claim 17, wherein the interconnection arrangement comprises a first interface having optical terminals couplable to some of the filter elements of the first and the second filter arrangements and a second interface having optical terminals couplable to some of the add and drop ports; wherein one or both of the first and second interfaces is moveable to couple different pairs of optical terminals from the first and second interfaces.

20. The interconnection arrangement of claim 19, wherein the optical terminals are annularly arranged on the respective first and second interfaces and wherein the first and second interfaces are rotatable with respect to each other and comprising a limiter mechanism to limit the coupling of the optical terminals to two rotational positions of the first and second interfaces corresponding to the first and second modes; wherein the limiter mechanism comprises a projection on one of the interfaces and two recesses for receiving the projection on the other interface.

21-22. (canceled)

23. The interconnection arrangement of claim 19, wherein the interconnection is manually operable to switch between the first and second modes.
